(19) United States
(12) Patent Application Publication
(10) Pub. No.: US 2026/0137235 A1
(43) Pub. Date: May 21, 2026

(54) LOCKING DEVICE AND CAKE MOLD

(71) Applicant: ROSEWILL ASIA COMPANY LIMITED, HONG KONG (CN)

(72) Inventor: WAI LUNG NG, HONG KONG (CN)

(21) Appl. No.: 19/386,567

(22) Filed: Nov. 12, 2025

(30) Foreign Application Priority Data
Nov. 19, 2024 (HK) 32024100210.6

(51) Int. Cl. A47J 37/01; A21B 3/13; A47J 43/20

(52) U.S. Cl. CPC A47J 37/01; A21B 3/137; A47J 43/20

(57) ABSTRACT

A locking device and a cake mold are disclosed. The locking device comprises a first connecting member, a second connecting member, a first locking member, and a second locking member. A first end of the first connecting member clamps a top end of a ring body, and a third end of the second connecting member clamps a bottom end. A fifth end of the first locking member is rotatably connected to a fourth end of the second connecting member and to a second end of the first connecting member. The fifth end rotates around an axis relative to the fourth end. A sixth end of the first locking member includes a first locking portion, and the second locking member includes a second locking portion. When the fifth end rotates to a locking position, a pulling force is applied to draw the ring body together, helping reduce loosening during baking.

### TECHNICAL FIELD

The present application relates to the technical field of cake molds, and particularly to a locking device and a cake mold.

### BACKGROUND ART

Cake molds are used for shaping cakes during cake making. Cake molds include ring bodies formed by winding long-strip-shaped steel sheets. The diameters of the ring bodies are changed by changing the overlapping degrees of the head and tail ends of the long-strip-shaped steel sheets, thereby being capable of making cakes of different sizes. Current cake molds use pressing pieces disposed on the long-strip-shaped steel sheets to tightly press the overlapped parts of the long-strip-shaped steel sheets to prevent relative sliding of the overlapped parts of the long-strip-shaped steel sheets. However, the design of tight pressing using the pressing pieces easily causes displacement or loosening during baking, further affecting the appearance of cakes.

### SUMMARY

In view of the problems existing in the background art, the present application aims to provide a locking device and a cake mold to overcome the above problems or at least partially solve the above problems.

According to a first aspect of the present application, a locking device is provided, including a first connecting member, a second connecting member, a first locking member, and a second locking member. The first connecting member includes a first end portion and a second end portion which are oppositely disposed, and the first end portion is used for clamping a top end of a ring body. The second connecting member includes a third end portion and a fourth end portion which are oppositely disposed, and the third end portion is used for clamping a bottom end of the ring body. The first locking member includes a fifth end portion and a sixth end portion which are oppositely disposed, the fifth end portion is rotatably connected to the fourth end portion, the fifth end portion is connected to the second end portion, the fifth end portion can rotate around an axis of rotation relative to the fourth end portion, and the sixth end portion is provided with a first locking portion. The second locking member is fixed to the second connecting member, and the second locking member is provided with a second locking portion. wherein when the fifth end portion rotates to a first position relative to the fourth end portion, the first locking portion and the second locking portion are locked, and the fifth end portion applies a pulling force to the second end portion and the fourth end portion, respectively, to drive the first end portion to get close to the third end portion.

In one or more of the above optional implementations, the first locking portion includes a slot portion, the second locking portion includes a clip, when the fifth end portion rotates to the first position relative to the fourth end portion, the sixth end portion is covered on the second locking member, and the clip is snap-fitted to the slot portion along a direction in which the sixth end portion is covered on the second locking member.

In one or more of the above optional implementations, the second locking member is provided with an elastic member, the second locking portion includes connecting arms, each of the connecting arms includes a seventh end portion and an eighth end portion which are oppositely disposed, the seventh end portion is rotatably connected to the second locking member, the clip is disposed on the eighth end portion, and the eighth end portion is connected to the elastic member. wherein the eighth end portion can reciprocate between a locked position and an unlocked position under driving of the seventh end portion, the clip is snap-fitted to the slot portion when the eighth end portion is at the locked position, the clip is separated from the slot portion when the eighth end portion is at the unlocked position, and the elastic member is used for generating an elastic action that resists a movement of the eighth end portion from the locked position toward the unlocked position.

In one or more of the above optional implementations, the second locking member is provided with an elastic member, the second locking portion includes connecting arms, each of the connecting arms includes a seventh end portion and an eighth end portion which are oppositely disposed, the seventh end portion is fixed to the second locking member, and the eighth end portion is connected to the elastic member. wherein the eighth end portion can be elastically bent relative to the seventh end portion to reciprocate between a locked position and an unlocked position, the clip is snap-fitted to the slot portion when the eighth end portion is at the locked position, the clip is separated from the slot portion when the eighth end portion is at the unlocked position, and the elastic member is used for generating an elastic action that resists a movement of the eighth end portion from the locked position toward the unlocked position.

In one or more of the above optional implementations, the slot portion includes a first slot portion and a second slot portion which are oppositely disposed, the number of the connecting arms is two, the clip includes a first clip and a second clip, the two connecting arms are oppositely disposed, the first clip and the second clip are disposed on the two eighth end portions, respectively, the elastic member includes a ninth end portion and a tenth end portion which are oppositely disposed, the ninth end portion is connected to one of the eighth end portions, the tenth end portion is connected to the other one of the eighth end portions, and when the fifth end portion rotates to the first position relative to the fourth end portion, the first clip is snap-fitted to the first slot portion, and the second clip is snap-fitted to the second slot portion.

In one or more of the above optional implementations, the second locking member is provided with an accommodating groove, a side wall of the accommodating groove is provided with a first opening and a second opening which are oppositely disposed, the elastic member and the second locking portion are both disposed in the accommodating groove, the first clip passes through the first opening, and the second clip passes through the second opening. the eighth end portions are provided with pressing portions, the pressing portions of the two eighth end portions are disposed back to back along a direction from the ninth end portion toward the tenth end portion, one of the pressing portions protrudes out of the second locking member through the first opening, and the other one of the pressing portions protrudes out of the second locking member through the second opening.

In one or more of the above optional implementations, the second locking member is provided with an accommodating groove, the elastic member and the second locking portion are both disposed in the accommodating groove, the second locking member is also provided with a first limiting hole and a second limiting hole which are oppositely disposed along a direction from the ninth end portion toward the tenth end portion, the first clip passes through the first limiting hole, and the second clip passes through the second limiting hole. the eighth end portions are provided with pressing portions, the pressing portions of the two eighth end portions are disposed back to back along a direction from the ninth end portion toward the tenth end portion, the second locking member is also provided with a third limiting hole and a fourth limiting hole which are oppositely disposed along the direction from the ninth end portion toward the tenth end portion, one of the pressing portions passes through the third limiting hole, and the other one of the pressing portions passes through the fourth limiting hole.

In one or more of the above optional implementations, the first end portion includes a first pressing piece, a first connecting portion, and a second pressing piece, the first pressing piece and the second pressing piece are oppositely disposed, the first connecting portion connects the first pressing piece to the second pressing piece, and a first clamping groove used for clamping the top end of the ring body is formed between the first pressing piece and the second pressing piece; and/or the third end portion includes a third pressing piece, a second connecting portion, and a fourth pressing piece, the third pressing piece and the fourth pressing piece are oppositely disposed, the second connecting portion connects the third pressing piece to the fourth pressing piece, and a second clamping groove used for clamping the bottom end of the ring body is formed between the third pressing piece and the fourth pressing piece; and/or the fifth end portion is provided with a first connecting hole and a second connecting hole, an axis of the first connecting hole is parallel to an axis of the second connecting hole, the second end portion is provided with a third connecting hole, the fourth end portion is provided with a fourth connecting hole, the first connecting hole is aligned with the third connecting hole along an axial direction of the first connecting hole, the second connecting hole is aligned with the fourth connecting hole, the locking device comprises a first connecting shaft and a second connecting shaft, the first connecting shaft passes through the first connecting hole and the third connecting hole, and the second connecting shaft passes through the second connecting hole and the fourth connecting hole.

According to a second aspect of the present application, a cake mold is provided, including a ring body and the locking device described above.

In one or more of the above optional implementations, the fourth end portion is fixed to an outer peripheral wall of the ring body; and/or the cake mold includes a limiting ring, and the limiting ring is sleeved on an overlapped part of the ring body.

The beneficial effects of embodiments of the present application are as follows: According to the locking device provided by the embodiments of the present application, the fifth end portion rotates relative to the fourth end portion to drive the first end portion to get close to the third end portion, so that the first end portion and the third end portion are fastened to the overlapped part of the ring body. Further, the first locking portion is locked to the second locking portion when the fifth end portion rotates to the first position, to lock the fifth end portion in the first position. Compared to traditional cake molds that only use an approach of tightly pressing the ring body by pressing pieces, the locking device provided by the embodiments of the present application is more reliable and helps reduce the occurrence of a problem of loosening of the ring body during baking.

### BRIEF DESCRIPTION OF THE DRAWINGS

To illustrate the specific embodiments of the present application or the technical solutions in the prior art more clearly, the drawings that need to be used in the descriptions of the specific embodiments or the prior art will be briefly introduced below. Throughout the drawings, similar elements or parts are generally identified by similar reference numbers. In the drawings, the elements or parts are not necessarily drawn to scale.

FIG. 1 is a stereoscopic diagram of a cake mold provided by an embodiment of the present application;

FIG. 2 is an exploded view of a locking device provided by an embodiment of the present application;

FIG. 3 is a cross-sectional view of a cake mold provided by an embodiment of the present application;

FIG. 4 is a schematic diagram of a first locking member of a locking device provided by an embodiment of the present application;

FIG. 5 is a schematic diagram of a first locking portion of a locking device provided by an embodiment of the present application;

FIG. 6 is a schematic diagram of a second locking member of a locking device provided by an embodiment of the present application;

FIG. 7 is a partial schematic diagram of locking between a first locking portion and a second locking portion of a locking device provided by an embodiment of the present application;

FIG. 8 is a partial exploded view of a locking device provided by an embodiment of the present application;

FIG. 9 is a schematic diagram of a second locking member of a locking device provided by an embodiment of the present application;

FIG. 10 is a schematic diagram of a first connecting member of a locking device provided by an embodiment of the present application; and

FIG. 11 is a schematic diagram of a second connecting member of a locking device provided by an embodiment of the present application.

### DETAILED DESCRIPTION

For ease of understanding of the present application, the present application is described below in more detail with reference to the drawings and specific embodiments. It should be noted that when an element is referred to as being “fixed to” another element, the element may be directly on another element, or one or more intermediate elements may exist therebetween. When an element is referred to as being “connected” to another element, the element may be directly connected to another element, or one or more intermediate elements may exist therebetween. The terms “vertical”, “horizontal”, “left”, “right”, “inner”, “outer”, and similar expressions used in the specification are for descriptive purposes only.

Unless otherwise defined, all technical and scientific terms used in the specification have the same meanings as those commonly understood by a person skilled in the art to which the present application belongs. The terms used in the specification of the present application are for the purpose of describing the specific embodiments only and are not intended to limit the present application. The term “and/or” used in the specification includes any and all combinations of one or more related listed items.

In the description of the specification, unless otherwise expressly specified or limited, the terms “link”, “connect”, and “fix” should be understood in a broad sense, for example, they may be a fixed connection, a detachable connection, or integration; they may be a mechanical connection or an electrical connection; and they may be a direct connection or an indirect connection through an intermediary; or internal communication between two elements or interaction between two elements. Those of ordinary skill in the art can understand the specific meanings of the above terms in the present disclosure according to specific situations.

In addition, the technical features described below in different embodiments of the present application can be combined as long as they do not conflict with each other.

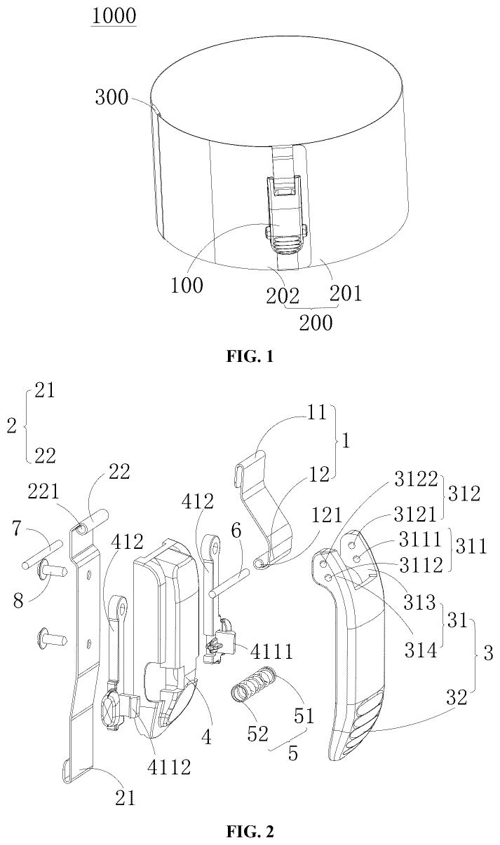

Referring to FIG. 1 to FIG. 5, a locking device 100 includes a first connecting member 1, a second connecting member 2, a first locking member 3, and a second locking member 4. The first connecting member 1 includes a first end portion 11 and a second end portion 12 which are oppositely disposed, and the first end portion 11 is used for clamping a top end of a ring body 200. The second connecting member 2 includes a third end portion 21 and a fourth end portion 22 which are oppositely disposed, and the third end portion 21 is used for clamping a bottom end of the ring body 200. The first locking member 3 includes a fifth end portion 31 and a sixth end portion 32 which are oppositely disposed. The fifth end portion 31 is rotatably connected to the fourth end portion 22, and the fifth end portion 31 is connected to the second end portion 12. The fifth end portion 31 can rotate around an axis of rotation z relative to the fourth end portion 22, to drive a joint between the second end portion 12 and the fifth end portion 31 to rotate around the axis of rotation z. The sixth end portion 32 is provided with a first locking portion 321. The second locking member 4 is fixed to the second connecting member 2, and the second locking member 4 is provided with a second locking portion 41. When the fifth end portion 31 rotates to a first position relative to the fourth end portion 22, the first locking portion 321 and the second locking portion 41 are locked, and the fifth end portion 31 applies a pulling force to the second end portion 12 and the fourth end portion 22, respectively, to drive the first end portion 11 to get close to the third end portion 21.

When the locking device 100 is used in a cake mold 1000, the first end portion 11 is fastened to a top end of an overlapped part 203 of the ring body 200, and the third end portion 21 is fastened to a bottom end of the overlapped part 203 of the ring body 200. When the fifth end portion 31 rotates to the first position relative to the fourth end portion 22, the fifth end portion 31 applies the pulling force to the second end portion 12 and the fourth end portion 22, respectively, to drive the first end portion 11 to get close to the third end portion 21, thereby fastening the overlapped part 203 of the ring body 200 through the first end portion 11 and the third end portion 21, to maintain the diameter of the ring body 200. The first locking portion 321 and the second locking portion 41 are locked, to fix the sixth end portion 32 to the second locking member 4.

According to the locking device 100 provided by the embodiments of the present application, the fifth end portion 31 rotates relative to the fourth end portion 22 to drive the first end portion 11 to get close to the third end portion 21, so that the first end portion 11 and the third end portion 21 are fastened to the overlapped part 203 of the ring body 200. Further, the first locking portion 321 is locked to the second locking portion 41 when the fifth end portion 31 rotates to the first position, to lock the fifth end portion 31 in the first position. Compared to traditional cake molds that only use an approach of tightly pressing the ring body by pressing pieces, the locking device 100 provided by the embodiments of the present application is more reliable and helps reduce the occurrence of a problem of loosening of the ring body 200 during baking.

In some embodiments, the first locking portion 321 includes a slot portion, and the second locking portion 41 includes a clip. The clip is snap-fitted to the slot portion when the fifth end portion 31 rotates to the first position relative to the fourth end portion 22.

In some embodiments, the sixth end portion 32 is covered on the second locking member 4 when the fifth end portion 31 rotates to the first position relative to the fourth end portion 22, and the clip is snap-fitted to the slot portion along a direction in which the first locking member 3 is covered on the second locking member 4.

In some embodiments, the second locking member 4 is provided with an elastic member 5, and the second locking portion 41 includes connecting arms 412. Each of the connecting arms 412 includes a seventh end portion 4121 and an eighth end portion 4122 which are oppositely disposed. The seventh end portion 4121 is rotatably connected to the second locking member 4, the clip is disposed on the eighth end portion 4122, and the eighth end portion 4122 is connected to the elastic member 5. The eighth end portion 4122 can reciprocate between a locked position and an unlocked position under driving of the seventh end portion 4121. The clip is snap-fitted to the slot portion when the eighth end portion 4122 is at the locked position. The clip is separated from the slot portion when the eighth end portion 4122 is at the unlocked position. The elastic member 5 is used for generating an elastic action that resists a movement of the eighth end portion 4122 from the locked position toward the unlocked position.

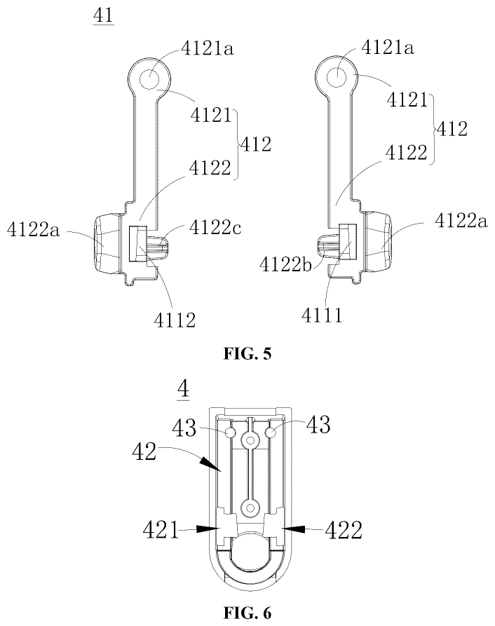

Referring to FIG. 5 and FIG. 6, in some embodiments, the seventh end portion 4121 is provided with a mounting hole 4121a, and the second locking member 4 is provided with a mounting protrusion 43. The mounting protrusion 43 is inserted into the mounting hole 4121a, and the seventh end portion 4121 can rotate around the mounting protrusion 43 through the mounting hole 4121a.

In some embodiments, each of the connecting arms 412 includes a connecting portion connected between the seventh end portion 4121 and the eighth end portion 4122. The connecting portion is generally in a shape of a long rod, and the connecting portion extends along a direction from the seventh end portion 4121 toward the eighth end portion 4122.

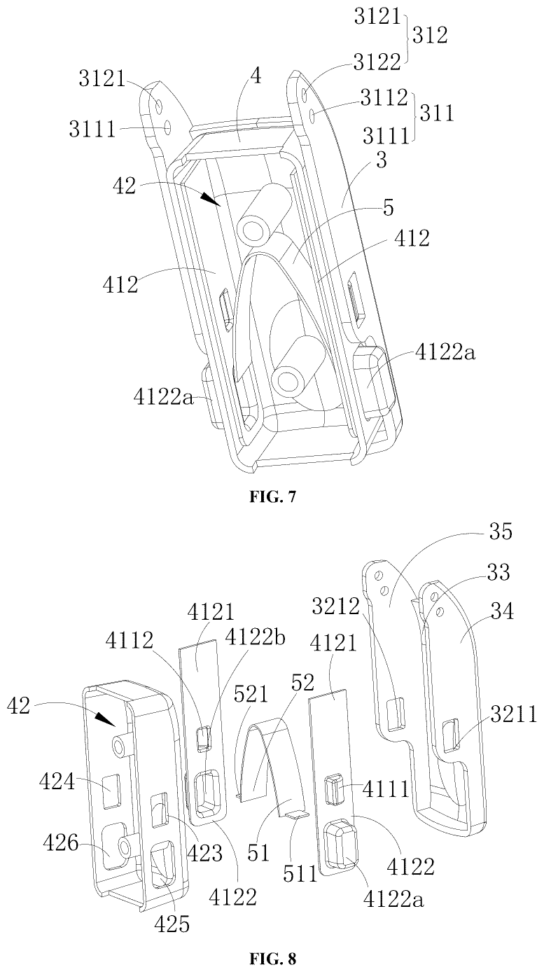

Referring to FIG. 7 and FIG. 8, in some other embodiments, the second locking member 4 is provided with an elastic member 5, and the second locking portion 41 includes connecting arms 412. Each of the connecting arms 412 includes a seventh end portion 4121 and an eighth end portion 4122 which are oppositely disposed. The seventh end portion 4121 is fixed to the second locking member 4, and the eighth end portion 4122 is connected to the elastic member 5. The eighth end portion 4122 can be elastically bent relative to the seventh end portion 4121 to reciprocate between a locked position and an unlocked position. The clip is snap-fitted to the slot portion when the eighth end portion 4122 is at the locked position. The clip is separated from the slot portion when the eighth end portion 4122 is at the unlocked position. The elastic member 5 is used for generating an elastic action that resists a movement of the eighth end portion 4122 from the locked position toward the unlocked position.

It can be understood that the seventh end portion 4121 can be fixed to the second locking member 4 in a manner of welding, fastening with a fastener, or bonding, and the like.

In some embodiments, the connecting arms 412 are generally in shapes of long pieces.

In some embodiments, the connecting arms 412 are made of metal. For example, the connecting arms 412 are made of elastic steel sheets.

Referring to FIG. 2, FIG. 4, and FIG. 5, in some embodiments, the slot portion includes a first slot portion 3211 and a second slot portion 3212 which are oppositely disposed. The number of the connecting arms 412 is two, and the clip includes a first clip 4111 and a second clip 4112. The two connecting arms 412 are oppositely disposed, and the first clip 4111 and the second clip 4112 are disposed on the two eighth end portions 4122, respectively. The elastic member 5 includes a ninth end portion 51 and a tenth end portion 52 which are oppositely disposed. The ninth end portion 51 is connected to one of the eighth end portions 4122, and the tenth end portion 52 is connected to the other one of the eighth end portions 4122. When the fifth end portion 31 rotates to the first position relative to the fourth end portion 22, the first clip 4111 is snap-fitted to the first slot portion 3211, and the second clip 4112 is snap-fitted to the second slot portion 3212.

In some embodiments, the elastic member 5 is used for generating the elastic action that resists the movement of the eighth end portion 4122 from the locked position toward the unlocked position under pressure. By pressing the two eighth end portions 4122 oppositely disposed, the two eighth end portions 4122 move toward each other, thereby driving the first clip 4111 and the second clip 4112 to avoid the first slot portion 3211 and the second slot portion 3212, respectively.

In other embodiments, the number of the connecting arms 412 is one. The clip only includes the first clip 4111, and the slot portion only includes the first slot portion 3211; or the clip only includes the second clip 4112, and the slot portion only includes the second slot portion 3212.

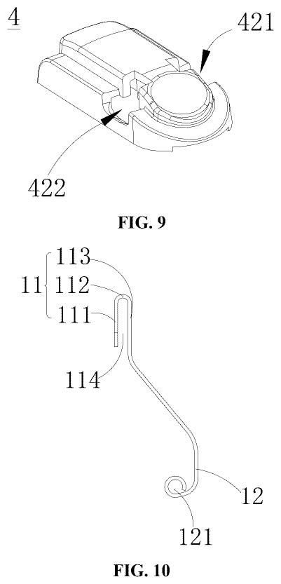

Referring to FIG. 2, FIG. 5, FIG. 6, and FIG. 9, in some embodiments, the second locking portion 41 is provided with an accommodating groove 42, and a side wall of the accommodating groove 42 is provided with a first opening 421 and a second opening 422 which are oppositely disposed. The elastic member 5 and the second locking portion 41 are both disposed in the accommodating groove 42, the first clip 4111 passes through the first opening 421, and the second clip 4112 passes through the second opening 422.

In some embodiments, the eighth end portions 4122 are provided with pressing portions 4122a, and the pressing portions 4122a of the two eighth end portions 4122 are disposed back to back along a direction from the ninth end portion 51 toward the tenth end portion 52. When the eighth end portion 4122 is at the locked position, one of the pressing portions 4122a protrudes out of the second locking member 4 through the first opening 421, and the other one of the pressing portions 4122a protrudes out of the second locking member 4 through the second opening 422. The pressing portion 4122a is used for facilitating a user to press the eighth end portion 4122.

In some embodiments, the elastic member 5 is a spring.

In some embodiments, a first limiting protrusion 4122b and a second limiting protrusion 4122c are disposed between the two eighth end portions 4122, respectively. The ninth end portion 51 is sleeved on the first limiting protrusion 4122b, and the tenth end portion 52 is sleeved on the second limiting protrusion 4122c.

In some embodiments, the mounting protrusion 43 protrudes out of the bottom of the accommodating groove 42.

Referring to FIG. 7 and FIG. 8, in some other embodiments, the second locking member 4 is provided with an accommodating groove 42, and the elastic member 5 and the second locking portion 4141 are both disposed in the accommodating groove 42. The second locking member 4 is also provided with a first limiting hole 423 and a second limiting hole 424 which are oppositely disposed along a direction from the ninth end portion 51 toward the tenth end portion 52. The first clip 4111 passes through the first limiting hole 423, and the second clip 4112 passes through the second limiting hole 424.

In some embodiments, both the first clip 4111 and the second clip 4112 are protruding structures formed integrally with the connecting arms 412. For example, a part of the connecting arms 412 forms the first clip 4111 after being recessed along a thickness direction.

In some embodiments, the connecting arms 412 are made of metal plates, and the first clip 4111 and the second clip 4112 are obtained by punching the metal plate along the thickness direction.

In some embodiments, the first locking member 3 includes a top wall 33, a first side wall 34, and a second side wall 35. The first side wall 34 and the second side wall 35 are oppositely disposed, and the top wall 33 is connected between the first side wall 34 and the second side wall 35. The first slot portion 3211 is disposed on the first side wall 34, and the second slot portion 3212 is disposed on the second side wall 35. When the first locking portion 321 and the second locking portion 41 are locked, the first side wall 34 and the second side wall 35 are respectively located on two sides which are back to back of the second locking member 4 along the direction from the ninth end portion 51 toward the tenth end portion 52. The first limiting hole 423 is aligned with the first slot portion 3211, and the second limiting hole 424 is aligned with the second slot portion 3212. The first clip 4111 passes through the first limiting hole 423 and the first slot portion 3211 sequentially, and the second clip 4112 passes through the second limiting hole 424 and the second slot portion 3212 sequentially.

In some embodiments, the eighth end portions 4122 are provided with pressing portions 4122a. The pressing portions 4122a of the two eighth end portions 4122 are disposed back to back along the direction from the ninth end portion 51 toward the tenth end portion 52. The second locking member 4 is also provided with a third limiting hole 425 and a fourth limiting hole 426 which are oppositely disposed along the direction from the ninth end portion 51 toward the tenth end portion 52. One of the pressing portions 4122a passes through the third limiting hole 425, and the other one of the pressing portions 4122a passes through the fourth limiting hole 426.

In some embodiments, the pressing portion 4122a is a protruding structure formed integrally with the connecting arms 412. For example, a part of the eighth end portion 4122 forms the pressing portion 4122a after being recessed along a thickness direction.

In some embodiments, the connecting arms 412 are made of metal plates, and the pressing portion 4122a is obtained by punching the metal plate along the thickness direction.

In some embodiments, the elastic member 5 is an elastic piece bent into a “V” shape, and a bend of the elastic member 5 can generate elastic deformation, so that the ninth end portion 51 and the tenth end portion 52 get close to or away from each other.

In some embodiments, the ninth end portion 51 of the elastic member is provided with a first inserting portion 511, and the tenth end portion 52 of the elastic member 5 is provided with a second inserting portion 521. Both opposite surfaces of the two connecting arms 412 are provided with inserting grooves 4122b. The first inserting portion 511 and the second inserting portion 521 are inserted into the inserting grooves 4122b of the two connecting arms 412, respectively.

In some embodiments, the part of the eighth end portion 4122 forms the inserting groove 4122b on a back surface of the pressing portion 4122a correspondingly after being recessed along the thickness direction to form the pressing portion 4122a.

In some embodiments, the first clip 4111 and one of the pressing portions 4122a are arranged on one of the connecting arms 412 sequentially along a direction from the seventh end portion 4121 toward the eighth end portion 4122. The second clip 4112 and the other one of the pressing portions 4122a are arranged on the other one of the connecting arms 412 sequentially along the direction from the seventh end portion 4121 toward the eighth end portion 4122.

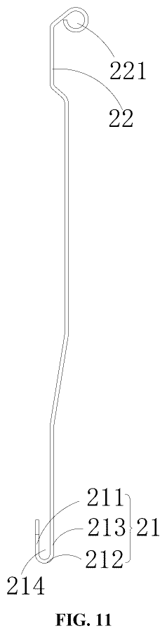

Referring to FIG. 2 to FIG. 4, FIG. 10, and FIG. 11, in some embodiments, the first end portion 11 includes a first pressing piece 111, a first connecting portion 112, and a second pressing piece 113. The first pressing piece 111 and the second pressing piece 113 are oppositely disposed. The first connecting portion 112 connects the first pressing piece 111 to the second pressing piece 113. A first clamping groove 114 used for clamping the top end of the ring body 200 is formed between the first pressing piece 111 and the second pressing piece 113.

In some embodiments, the third end portion 21 includes a third pressing piece 211, a second connecting portion 212, and a fourth pressing piece 213. The third pressing piece 211 and the fourth pressing piece 213 are oppositely disposed. The second connecting portion 212 connects the third pressing piece 211 to the fourth pressing piece 213. A second clamping groove 214 used for clamping the bottom end of the ring body 200 is formed between the third pressing piece 211 and the fourth pressing piece 213.

In some embodiments, the fifth end portion 31 is provided with a first connecting hole 311 and a second connecting hole 312. An axis of the first connecting hole 311 is parallel to an axis of the second connecting hole 312. The second end portion 12 is provided with a third connecting hole 121, and the fourth end portion 22 is provided with a fourth connecting hole 221. The first connecting hole 311 is aligned with the third connecting hole 121 along an axial direction of the first connecting hole 311, and the second connecting hole 312 is aligned with the fourth connecting hole 221. The locking device 100 includes a first connecting shaft 6 and a second connecting shaft 7. The first connecting shaft 6 passes through the first connecting hole 311 and the third connecting hole 121, and the second connecting shaft 7 passes through the second connecting hole 312 and the fourth connecting hole 221.

In some embodiments, the fifth end portion 31 includes a first mounting portion 313 and a second mounting portion 314 which are oppositely disposed. The first connecting hole 311 includes a first hole portion 3111 and a second hole portion 3112. The first hole portion 3111 is disposed on the first mounting portion 313, and the second hole portion 3112 is disposed on the second mounting portion 314. The second connecting hole 312 includes a third hole portion 3121 and a fourth hole portion 3122. The third hole portion 3121 is disposed on the first mounting portion 313, and the fourth hole portion 3122 is disposed on the second mounting portion 314. An accommodating space a is defined between the first mounting portion 313 and the second mounting portion 314. A part of the second end portion 12 provided with the third connecting hole 121 is located in the accommodating space a. A part of the fourth end portion 22 provided with the fourth connecting hole 221 is located in the accommodating space a. The first connecting shaft 6 passes through the first hole portion 3111, the third connecting hole 121, and the second hole portion 3112 sequentially. The second connecting shaft 7 passes through the third hole portion 3121, the fourth connecting hole 221, and the fourth hole portion 3122 sequentially.

In some embodiments, the first connecting member 1 is formed by bending a strip-shaped metal sheet.

In some embodiments, the second connecting member 2 is formed by bending a strip-shaped metal sheet.

In some embodiments, the first connecting member 1 and the second connecting member 2 include but are not limited to being made of 304 stainless steel.

In some embodiments, the locking device 100 includes a connecting bolt 8, and the connecting bolt 8 is fixed to the second locking member 4 in a screw joint mode after passing through the second connecting member 2.

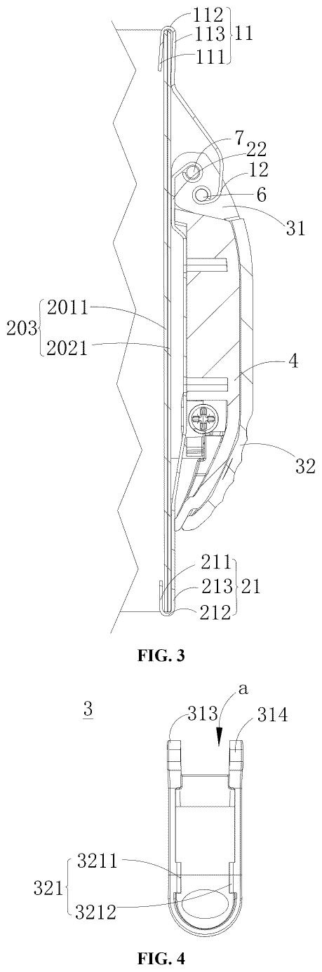

Referring to FIG. 1 and FIG. 3, based on the same inventive concept, the present application also provides a cake mold 1000, including the ring body 200 and the locking device 100 in any of the above embodiments.

In some embodiments, the ring body 200 includes an eleventh end portion 201 and a twelfth end portion 202. The eleventh end portion 201 and the twelfth end portion 202 at least partially overlap along a radial direction of the ring body 200. A part 2011 of the eleventh end portion 201 overlapped with the twelfth end portion 202 and a part 2021 of the twelfth end portion 202 overlapped with the eleventh end portion 201 constitute the overlapped part 203 of the ring body 200. The eleventh end portion 201 and the twelfth end portion 202 can slide around an axis of the ring body 200 relative to each other, thereby increasing or decreasing an overlapped area between the eleventh end portion 201 and the twelfth end portion 202, and further increasing or decreasing the diameter of the ring body 200.

In some embodiments, the ring body 200 is formed by winding a stainless steel sheet.

In some embodiments, the cake mold 1000 includes a limiting ring 300, and the limiting ring 300 is sleeved on the overlapped part 203 of the ring body 200. The limiting ring 300 is used for limiting the overlapped part 203 of the ring body 200 in an axial direction of the ring body 200.

In some embodiments, the fourth end portion 22 is fixed to an outer peripheral wall of the ring body 200. The fourth end portion 22 is fixed to an outer peripheral portion of the ring body 200, which helps reduce the occurrence of a problem that the second locking member 4 drives the fourth end portion 22 to swing relative to the ring body 200 when the first locking portion 321 is not locked with the second locking portion 41.

In some embodiments, the fourth end portion 22 is welded and fixed to the outer peripheral wall of the ring body 200. It can be understood that in some other embodiments, the fourth end portion 22 can also be fixed to the ring body 200 in a manner of bonding, riveting, or the like.

The above descriptions are only embodiments of the present application and do not limit the patent scope of the present application. The equivalent structure or the equivalent process transformation made by using the specification and the content of the drawings of the present application or directly or indirectly used in other related technical fields is included in the patent protection scope of the present application in the same way.

What is claimed is:

1. A locking device, comprising:
a first connecting member, comprising a first end portion and a second end portion which are oppositely disposed, wherein the first end portion is used for clamping a top end of a ring body;
a second connecting member, comprising a third end portion and a fourth end portion which are oppositely disposed, wherein the third end portion is used for clamping a bottom end of the ring body;
a first locking member, comprising a fifth end portion and a sixth end portion which are oppositely disposed, wherein the fifth end portion is rotatably connected to the fourth end portion, the fifth end portion is connected to the second end portion, the fifth end portion can rotate around an axis of rotation relative to the fourth end portion, and the sixth end portion is provided with a first locking portion; and
a second locking member fixed to the second connecting member, wherein the second locking member is provided with a second locking portion,
wherein when the fifth end portion rotates to a first position relative to the fourth end portion, the first locking portion and the second locking portion are locked, and the fifth end portion applies a pulling force to the second end portion and the fourth end portion, respectively, to drive the first end portion to get close to the third end portion.

2. The locking device according to claim 1, wherein
the first locking portion comprises a slot portion, the second locking portion comprises a clip, when the fifth end portion rotates to the first position relative to the fourth end portion, the sixth end portion is covered on the second locking member, and the clip is snap-fitted to the slot portion along a direction in which the sixth end portion is covered on the second locking member.

3. The locking device according to claim 2, wherein
the second locking member is provided with an elastic member, the second locking portion comprises connecting arms, each of the connecting arms comprises a seventh end portion and an eighth end portion which are oppositely disposed, the seventh end portion is rotatably connected to the second locking member, the clip is disposed on the eighth end portion, and the eighth end portion is connected to the elastic member,
wherein the eighth end portion can reciprocate between a locked position and an unlocked position under driving of the seventh end portion, the clip is snap-fitted to the slot portion when the eighth end portion is at the locked position, the clip is separated from the slot portion when the eighth end portion is at the unlocked position, and the elastic member is used for generating an elastic action that resists a movement of the eighth end portion from the locked position toward the unlocked position.

4. The locking device according to claim 2, wherein
the second locking member is provided with an elastic member, the second locking portion comprises connecting arms, each of the connecting arms comprises a seventh end portion and an eighth end portion which are oppositely disposed, the seventh end portion is fixed to the second locking member, and the eighth end portion is connected to the elastic member,
wherein the eighth end portion can be elastically bent relative to the seventh end portion to reciprocate between a locked position and an unlocked position, the clip is snap-fitted to the slot portion when the eighth end portion is at the locked position, the clip is separated from the slot portion when the eighth end portion is at the unlocked position, and the elastic member is used for generating an elastic action that resists a movement of the eighth end portion from the locked position toward the unlocked position.

5. The locking device according to claim 3, wherein
the slot portion comprises a first slot portion and a second slot portion which are oppositely disposed, the number of the connecting arms is two, the clip comprises a first clip and a second clip, the two connecting arms are oppositely disposed, the first clip and the second clip are disposed on the two eighth end portions, respectively, the elastic member comprises a ninth end portion and a tenth end portion which are oppositely disposed, the ninth end portion is connected to one of the eighth end portions, the tenth end portion is connected to the other one of the eighth end portions, and when the fifth end portion rotates to the first position relative to the fourth end portion, the first clip is snap-fitted to the first slot portion, and the second clip is snap-fitted to the second slot portion.

6. The locking device according to claim 5, wherein
the second locking member is provided with an accommodating groove, a side wall of the accommodating groove is provided with a first opening and a second opening which are oppositely disposed, the elastic member and the second locking portion are both disposed in the accommodating groove, the first clip passes through the first opening, and the second clip passes through the second opening; and
the eighth end portions are provided with pressing portions, the pressing portions of the two eighth end portions are disposed back to back along a direction from the ninth end portion toward the tenth end portion, one of the pressing portions protrudes out of the second locking member through the first opening, and the other one of the pressing portions protrudes out of the second locking member through the second opening.

7. The locking device according to claim 5, wherein
the second locking member is provided with an accommodating groove, the elastic member and the second locking portion are both disposed in the accommodating groove, the second locking member is also provided with a first limiting hole and a second limiting hole which are oppositely disposed along a direction from the ninth end portion toward the tenth end portion, the first clip passes through the first limiting hole, and the second clip passes through the second limiting hole; and
the eighth end portions are provided with pressing portions, the pressing portions of the two eighth end portions are disposed back to back along a direction from the ninth end portion toward the tenth end portion, the second locking member is also provided with a third limiting hole and a fourth limiting hole which are oppositely disposed along the direction from the ninth end portion toward the tenth end portion, one of the pressing portions passes through the third limiting hole, and the other one of the pressing portions passes through the fourth limiting hole.

8. The locking device according to claim 1, wherein
the first end portion comprises a first pressing piece, a first connecting portion, and a second pressing piece, the first pressing piece and the second pressing piece are oppositely disposed, the first connecting portion connects the first pressing piece to the second pressing piece, and a first clamping groove used for clamping the top end of the ring body is formed between the first pressing piece and the second pressing piece; and/or
the third end portion comprises a third pressing piece, a second connecting portion, and a fourth pressing piece, the third pressing piece and the fourth pressing piece are oppositely disposed, the second connecting portion connects the third pressing piece to the fourth pressing piece, and a second clamping groove used for clamping the bottom end of the ring body is formed between the third pressing piece and the fourth pressing piece; and/or
the fifth end portion is provided with a first connecting hole and a second connecting hole, an axis of the first connecting hole is parallel to an axis of the second connecting hole, the second end portion is provided with a third connecting hole, the fourth end portion is provided with a fourth connecting hole, the first connecting hole is aligned with the third connecting hole along an axial direction of the first connecting hole, the second connecting hole is aligned with the fourth connecting hole, the locking device comprises a first connecting shaft and a second connecting shaft, the first connecting shaft passes through the first connecting hole and the third connecting hole, and the second connecting shaft passes through the second connecting hole and the fourth connecting hole.

9. A cake mold, comprising:
a ring body; and
the locking device according to claim 1.

10. The cake mold according to claim 9, wherein
the fourth end portion is fixed to an outer peripheral wall of the ring body; and/or
the cake mold comprises a limiting ring, and the limiting ring is sleeved on an overlapped part of the ring body.
